(19) United States
(12) Patent Application Publication
(10) Pub. No.: US 2016/0361978 A1
(43) Pub. Date: Dec. 15, 2016

(54) PERSONAL AIR FLOW DEVICE FOR A VEHICLE

(71) Applicant: Dr. Ing. h.c. F. Porsche Aktiengesellschaft, Stuttgart (DE)

(72) Inventor: Thomas Groschopf, Schneidenbach (DE)

(21) Appl. No.: 15/155,159

(22) Filed: May 16, 2016

(30) Foreign Application Priority Data
Jun. 9, 2015 (DE) 10 2015 109 068.6

(51) Int. Cl. B60H 1/34

(52) U.S. Cl. CPC B60H 1/3428

(57) ABSTRACT

A personal air flow device for a vehicle is provided. The personal air flow device (10) comprises a plurality of air flow ducts (11, 12) with a common air exit region for the outflow of a desired total air mass flow. Each air flow duct (11, 12) is connected to the air exit region in such a way that the air flow duct (11, 12) applies an air mass flow (\dot{m}₁, \dot{m}₂) to the air exit region. The air mass flows (\dot{m}₁, \dot{m}₂) can be controlled relative to one another in such a way that they are superimposed to form the total air mass flow. The direction of the total mass flow can be adjusted (infinitely or in increments) by changing the impetuses of the individual air mass flows.

### CROSS REFERENCE TO RELATED APPLICATION

This application claims priority under 35 USC 119 to German Patent Appl. No. 10 2015 109 068.6 filed on Jun. 9, 2015, the entire disclosure of which is incorporated herein by reference.

### BACKGROUND

1. Field of the Invention

The invention relates to a personal air flow device for a vehicle.

2. Description of the Related Art

Personal air flow devices, dashboard vents or air outlets are terms used in vehicle technology to refer to the air distributors and air nozzles for a wide variety of air ducts in or under the dashboard, in the ceiling-mounted air-conditioning system or for the warm air blower or cold air blower behind and/or under the front seats of the passenger compartment of a vehicle.

DE 100 03 798 B4 describes a device with two air outlets for ventilating the passenger compartment of a vehicle. The device can move the impact location of the two air jets to permit both diffuse flow conditions and air jets with a long range to be generated, as well as allowing any desired flow directions to be set. The setting of the flow direction can be made by adjustable air-guiding lamellas in the air outlets.

DE 102 35 526 A1 also describes the alternating influencing of two air jets after they flow into the passenger compartment of the vehicle. The direction of the air flows can be adjusted by movable air-guiding lamellas. In addition, a fan effect can be generated by alternating shutting and opening of the air ducts using additional closing flaps.

The invention makes provides a personal air flow device for a vehicle.

### SUMMARY

The invention relates to an air flow device configured so that it is no longer necessary to provide any adjustable lamellas. Rather, the air flow is influenced by the orientation of fixed lamellas or even only by housing walls. The impetuses of various air flows are shaped as a result in such a way that the direction of resulting air flows can be changed. Parameters of these impetuses are the direction, flow speed and air mass. Further parameters that can exert an influence with this principle are the arrangement of the air ducts that influence one another as well as the position of the point at which the flows interact.

It is possible, in principle, for it to be sufficient to change one of the six specified parameters—cross section, flow speed, air mass, direction, arrangement of the air ducts that influence one another, and the position of the point at which the flows interact. However, it is also possible for a compromise or interplay of all or several of these parameters to be implemented. It is necessary to consider, for example the same cross section with a different mass flow, the same mass flow with different cross sections, a separate mass flow for each duct or a single mass flow that is divided into ducts, changing of the mass flow by means of an air-conditioning unit, shut-off flaps or a change in the cross section (in each case infinite or incremental), a change in direction by means of air-guiding elements, a change in direction by changing the duct position, a change in direction by opening or closing a bypass that has an outflow or outward suction, a direction that is predefined permanently by a flow duct, arrangement of the ducts, for example, in a triangle, in a star shape or linearly, a different shape, for example round or rectangular, of the ducts, an identical or different number of ducts, position of the point at which the flows interact, for example spatial separation or combination of the individual air flows in a duct, or an outflow that can be adjusted in the manner of a spot or diffusely.

An exemplary embodiment of the invention is illustrated in the drawing and will be described in more detail below.

### BRIEF DESCRIPTION OF THE DRAWINGS

FIG. 1 is a longitudinal cross section through a personal air flow device according to a first embodiment.

FIG. 2 is a longitudinal cross section through a personal air flow device according to a second embodiment.

FIG. 3 is a longitudinal section through a personal air flow device according to a third embodiment.

FIG. 4 is a longitudinal section through a personal air flow device according to a fourth embodiment.

FIG. 5 is a longitudinal section through a personal air flow device according to a fifth embodiment.

FIG. 6 is a longitudinal section through a personal air flow device according to a sixth embodiment.

FIG. 7 is a longitudinal section through a personal air flow device according to a seventh embodiment.

FIG. 8 is a longitudinal section through a personal air flow device according to an eighth embodiment.

FIG. 9 is a longitudinal section through a personal air flow device according to a ninth embodiment.

FIG. 10 is a longitudinal section through a personal air flow device according to a tenth embodiment.

FIG. 11 is a perspective view of a personal air flow device according to an eleventh embodiment.

FIG. 12 shows a calculation example for the personal air flow device according to the eleventh embodiment.

FIG. 13 is a perspective view of a personal air flow device according to a twelfth embodiment.

FIG. 14 is a perspective view of a personal air flow device according to a thirteenth embodiment.

FIG. 15 shows the front view through a personal air flow device according to a fourteenth embodiment.

FIG. 16 is a perspective view through the personal air flow device according to the fourteenth embodiment.

FIG. 17 is a perspective view through a personal air flow device according to a fifteenth embodiment.

FIG. 18 is a perspective view of a personal air flow device according to a sixteenth embodiment.

FIGS. 19 to 22 are examples of possible duct arrangements.

### DETAILED DESCRIPTION

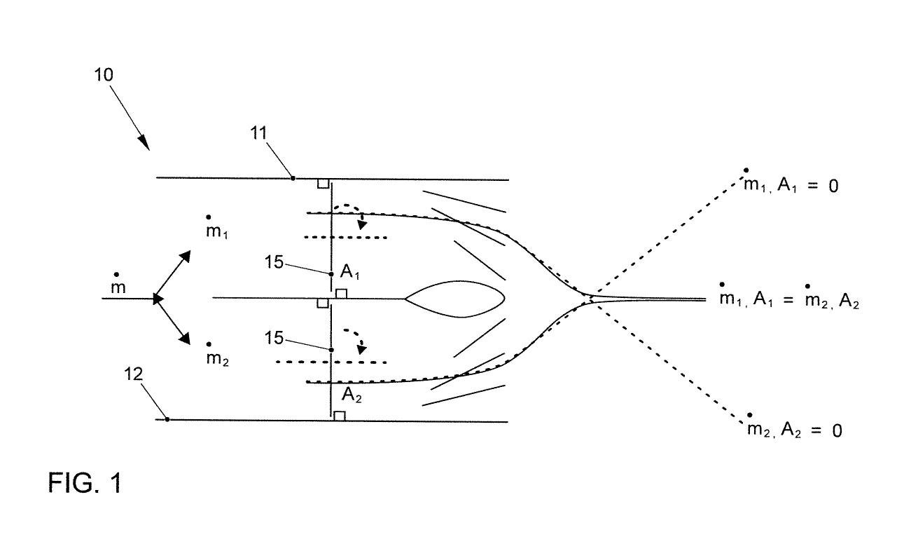

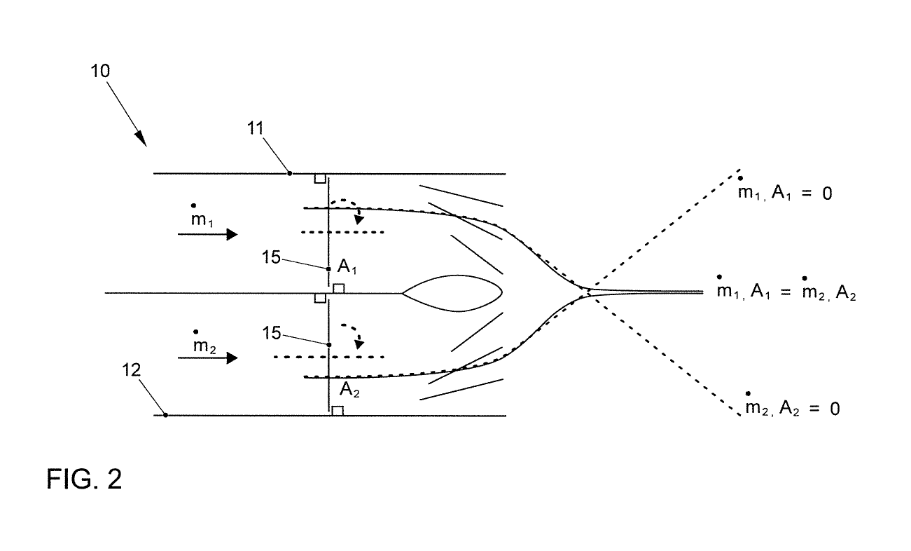

FIGS. 1 to 4 illustrate the basic design of a personal air flow device 10 for a vehicle according to first, second, third and fourth embodiments. Each of these personal air flow devices 10 comprises two air flow ducts 11, 12 and one air exit region that is common to the two air flow ducts 11, 12 for the outflow of a desired total air mass flow. Each of the two air flow ducts 11, 12 is connected to the air exit region in such a way that the respective air flow duct 11, 12 applies an air mass flow \dot{m}₁, \dot{m}₂ to the air exit region. In the first embodiment in FIG. 1, for this purpose a mass flow \dot{m} is divided, while in the second embodiment in FIG. 2 two air flow ducts 11, 12 that are separated completely from one another are combined.

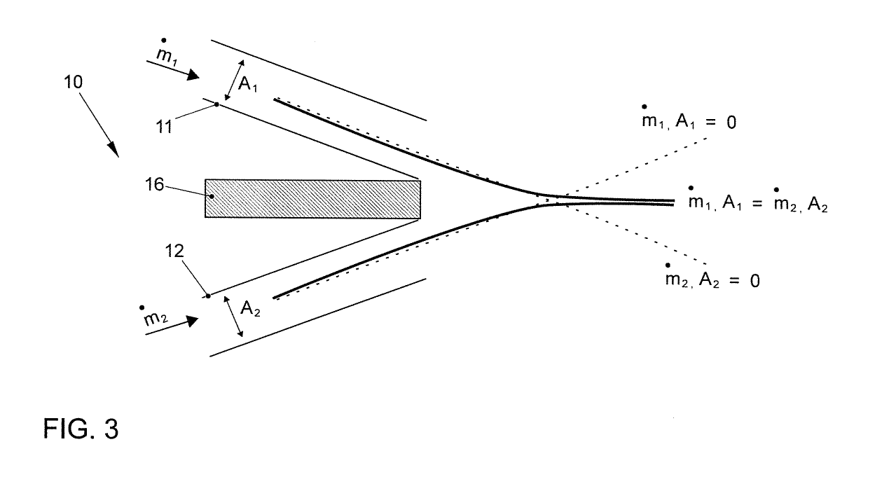

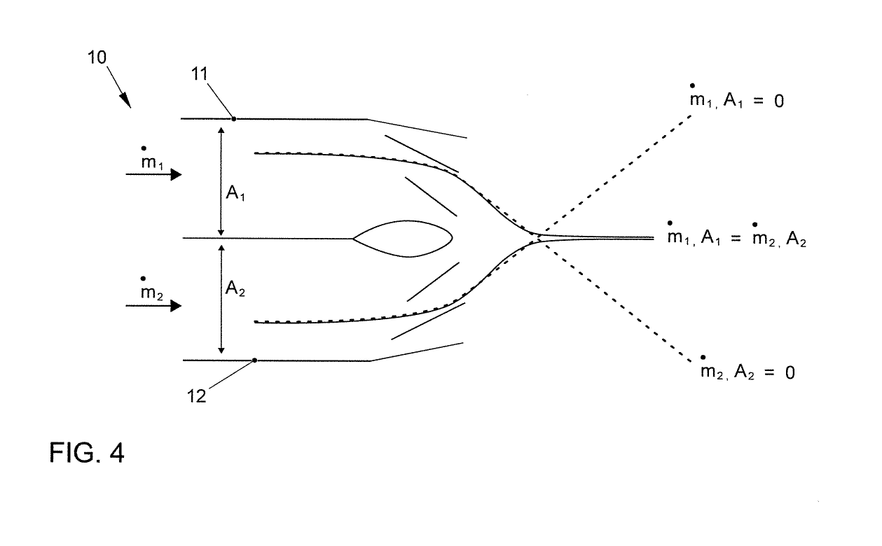

The air mass flows \dot{m}₁, \dot{m}₂ can be controlled relative to one another in such a way that they are superimposed to form a total air mass flow whose direction can be controlled according to the discussed embodiments by modifying the cross section A₁, A₂ and/or the throughput rate \dot{m}₁, \dot{m}₂ of at least one of the two air flow ducts 11, 12. The direction of the total air mass flow can be adjusted by a changing, brought about in this way, of the impetuses of the individual interacting air mass flows \dot{m}₁, \dot{m}₂. The air flow ducts 11, 12 according to the first and second embodiments have for this purpose a flap 15 for reducing their respective cross section A₁, A₂, while the air mass flows \dot{m}₁, rimₑ which are shown in FIGS. 3 and 4 can be regulated by an air-conditioning unit that is connected to the personal air flow device 10 of the respective vehicle. The third embodiment in FIG. 3 shows local separation 16 of the two air flow ducts 11, 12.

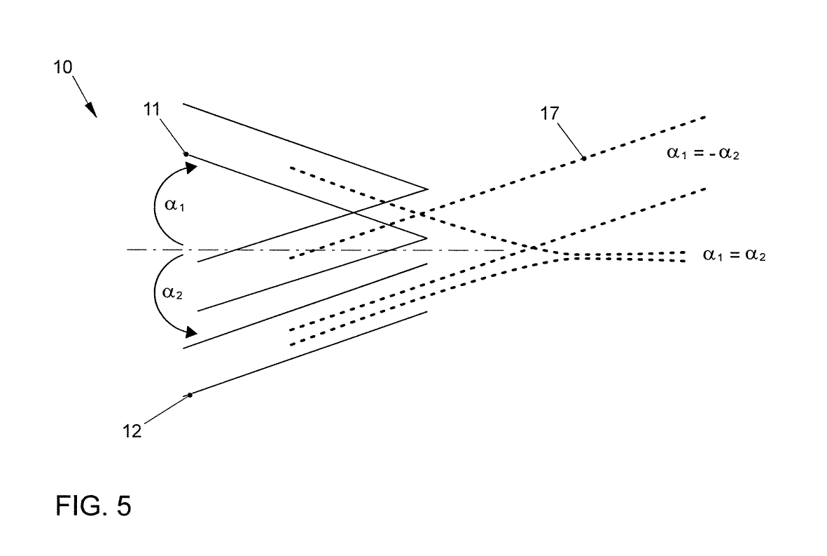

The fifth embodiment in FIG. 5 clarifies the possible changing of the direction by modifying the angles α₁, α₂ of two interacting air mass flows. Depending on the angle α₁, α₂ of the two air flow ducts 11, 12 that influence one another, a resulting total air mass flow comes about. In the case of FIG. 5, in this respect at least the angle α₁ of the upper duct 11 can be changed in such a way that it is moved into the end position 17. The angle of the resulting air mass flow then is directed from the horizontal in the figure to the upper edge of FIG. 5.

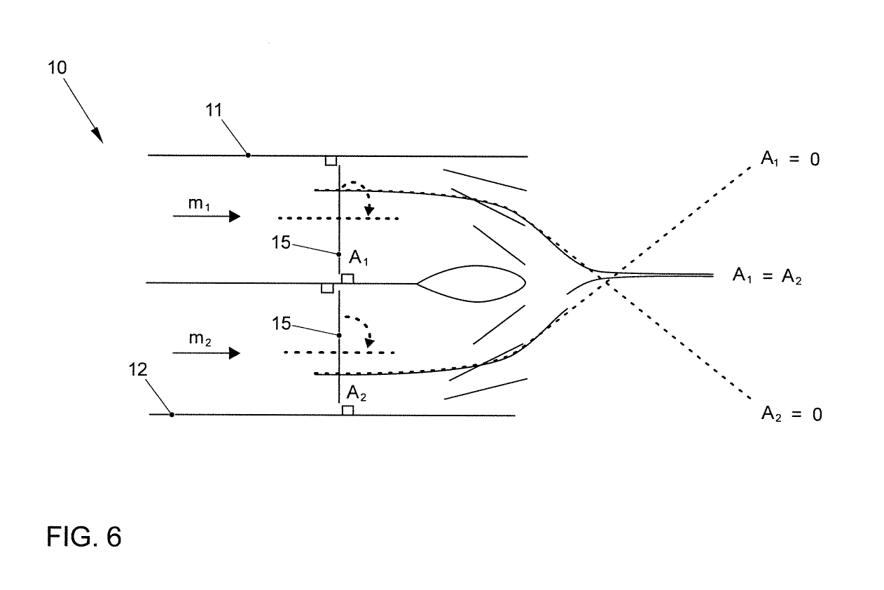

A further example of an angle controller is illustrated in FIG. 6 on the basis of a sixth embodiment. Air-directing elements preferably are positioned rigidly in the flow to direct the two air mass flows \dot{m}₁, \dot{m}₂ in the desired direction.

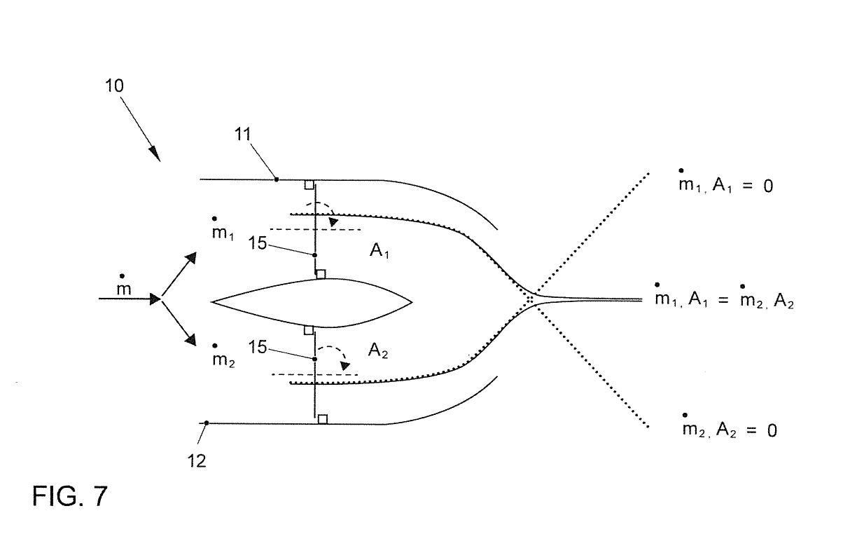

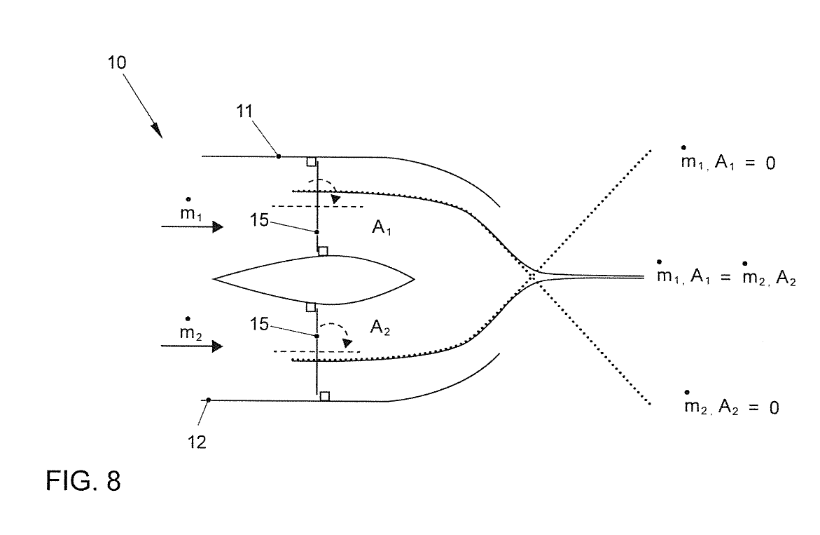

A comparable effect can be achieved equally well without the use of air-directing elements. In the seventh embodiment in FIG. 7, in this respect a mass flow \dot{m} is divided, while in the eighth embodiment in FIG. 8 two air flow ducts 11, 12 that are separated completely from one another are combined.

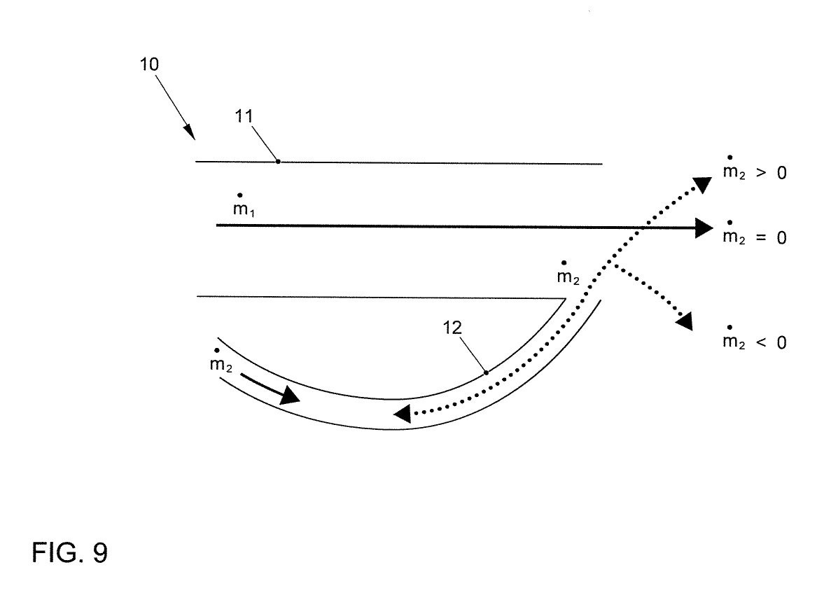

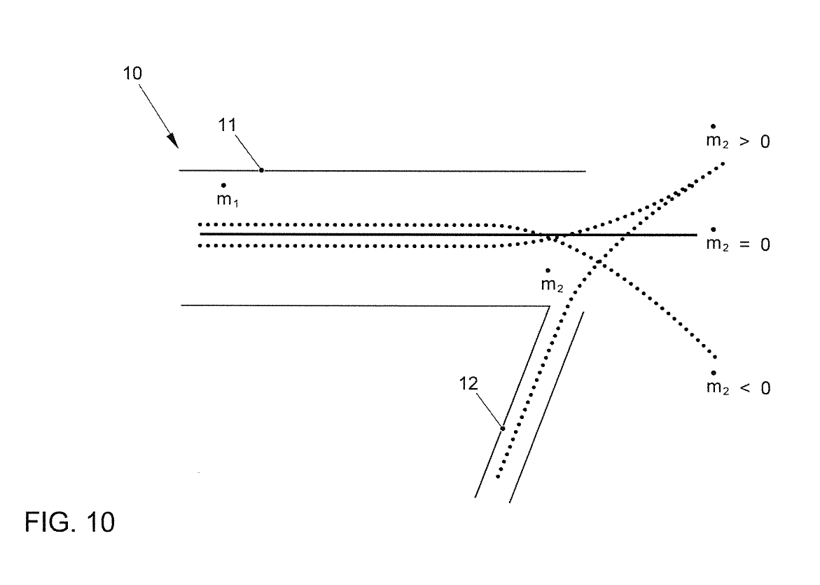

In the ninth embodiment in FIG. 9, the changing of the direction is effected by excess pressure or under-pressure at the flow outlet. For this purpose, when necessary under-pressure is tapped to suck out air at the flow outlet. As a result, the constant main flow \dot{m}₁ is deflected down according to the figure. Alternatively, a ram pressure or excess pressure is generated. This can be tapped when necessary to blow in air at the flow outlet. As a result, the horizontal main flow \dot{m}₁ is deflected up according to the figure. This active principle also is satisfied by the tenth embodiment in FIG. 10 with slightly different geometry.

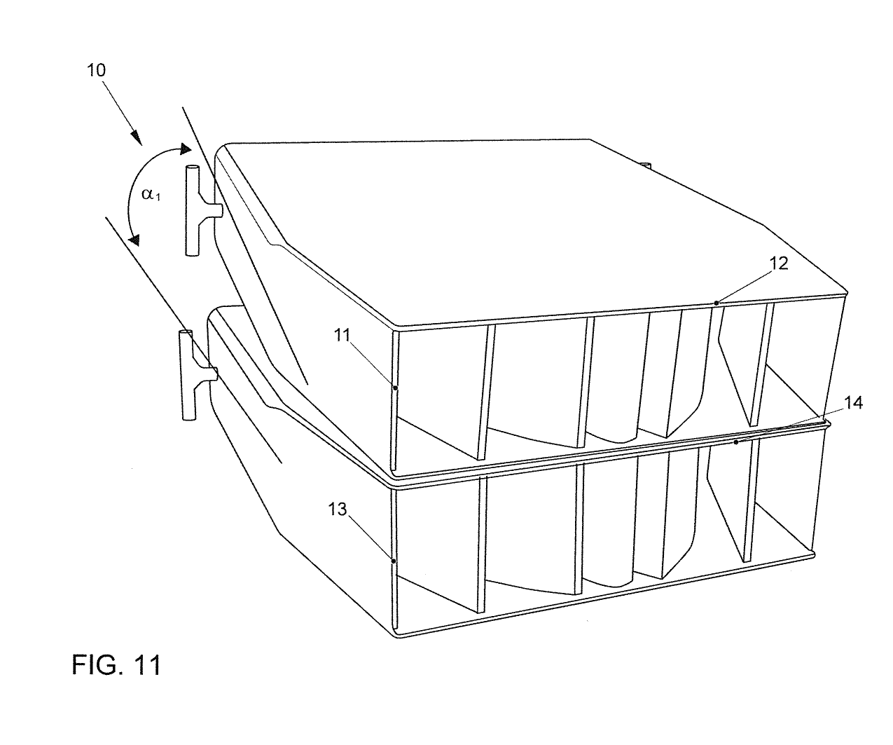

An eleventh embodiment is illustrated in FIG. 11. In this implementation example, the personal air flow device 10 comprises two lower air flow ducts 11, 12 and two upper air flow ducts 13, 14 that are oriented at a fixed angle α₁ with respect to the lower air flow ducts 13, 14.

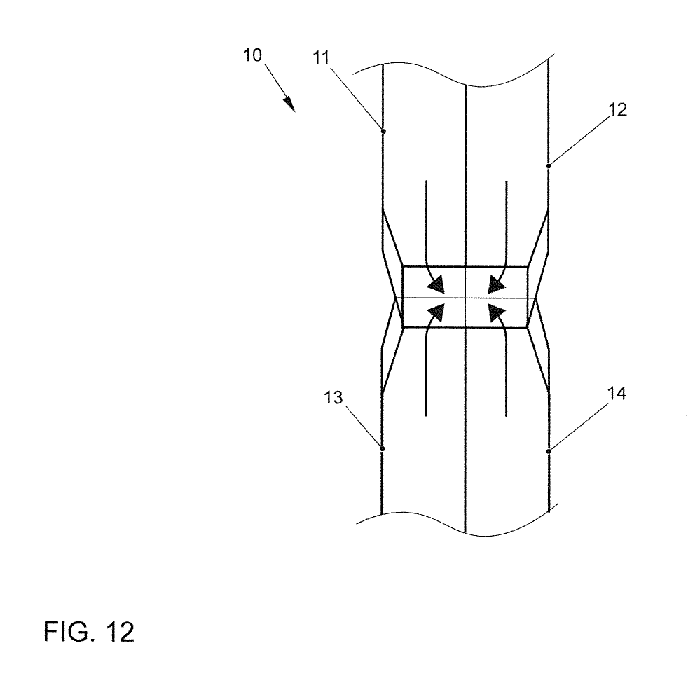

In addition, all four blowing-out points have fixed lamellas, with the result that the air mass flows intersect. Depending on which air mass flow has the greatest impetus, a certain total air mass flow therefore is produced. For instance, in the calculation example in FIG. 12 all the air flow ducts 11, 12, 13, 14 supply the same impetus. The resulting air flow therefore points from the plane of the drawing in the direction of the observer.

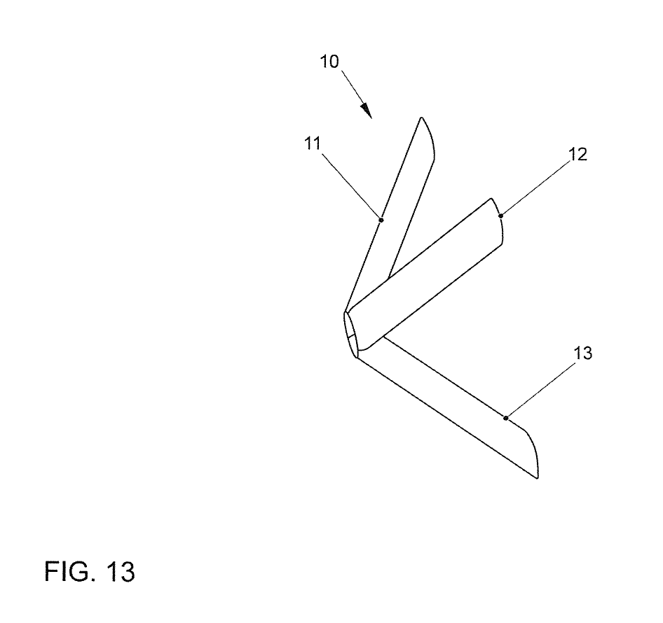

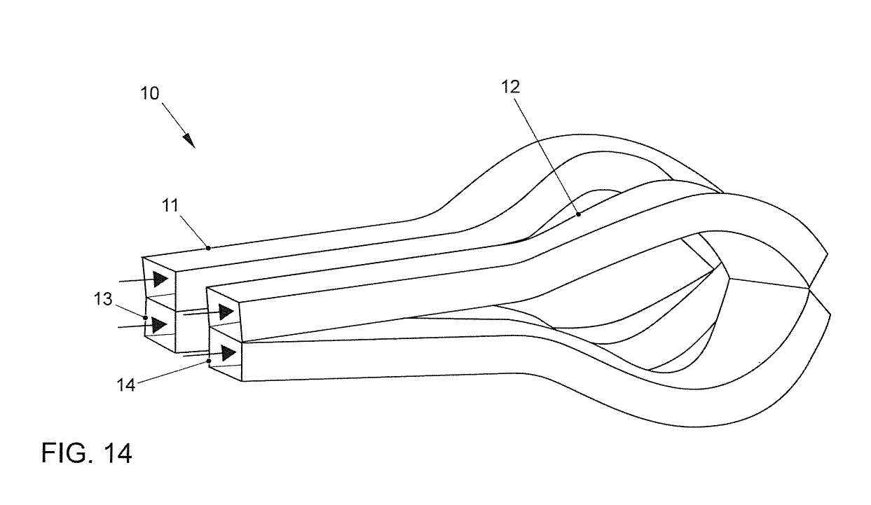

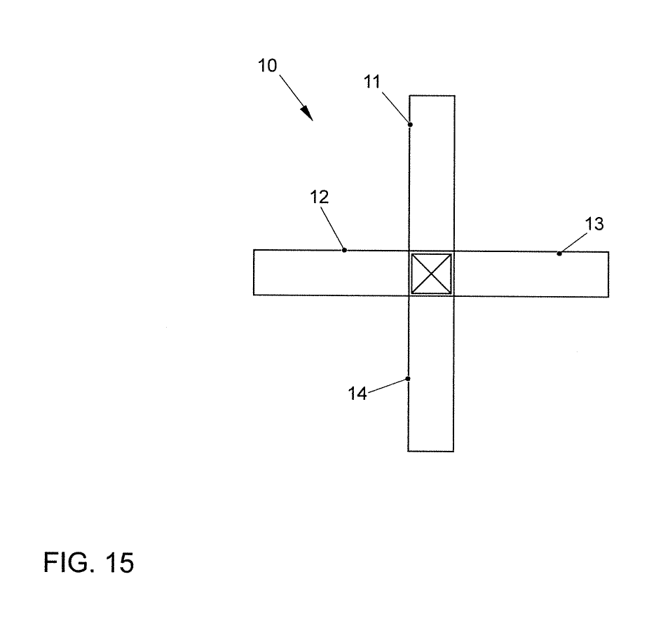

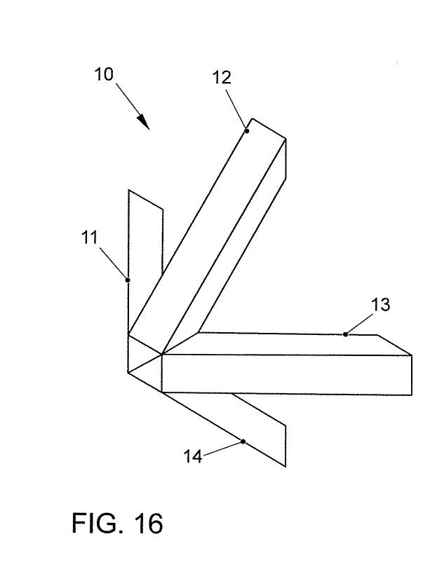

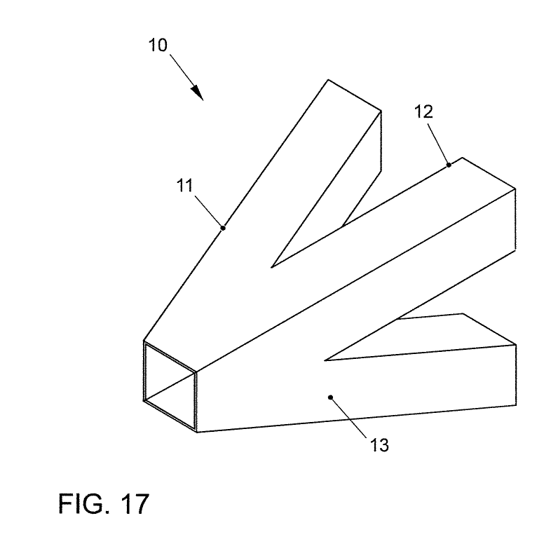

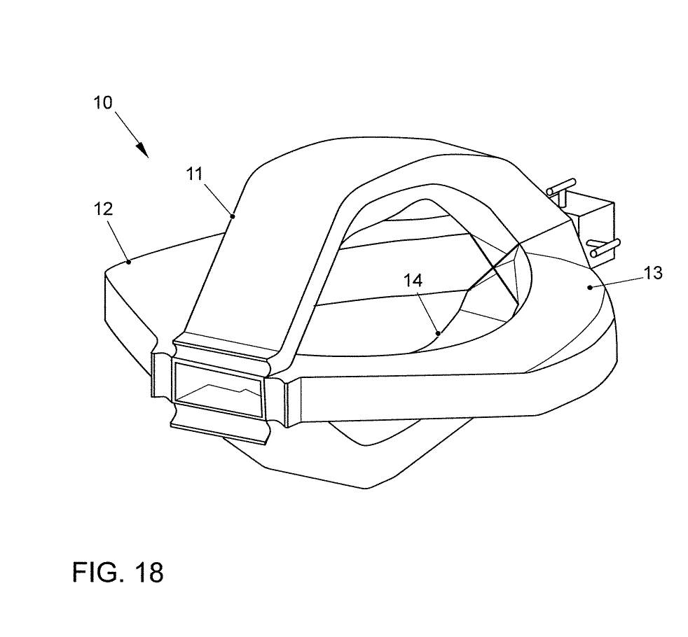

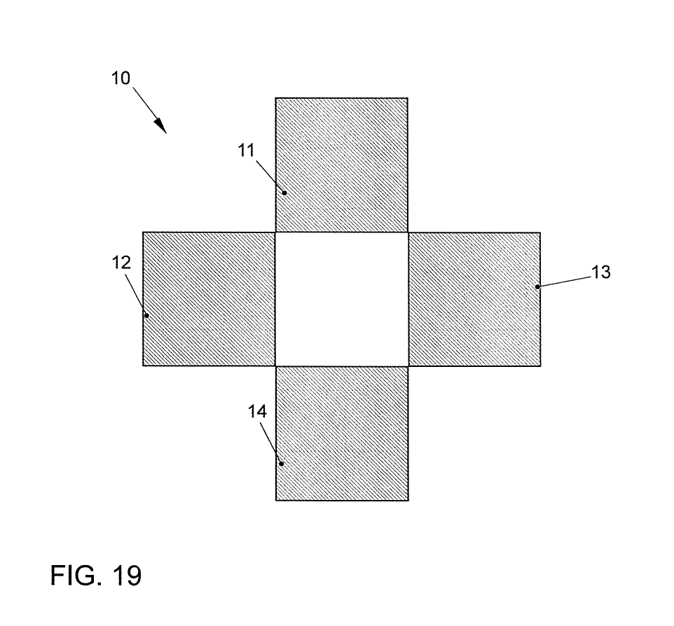

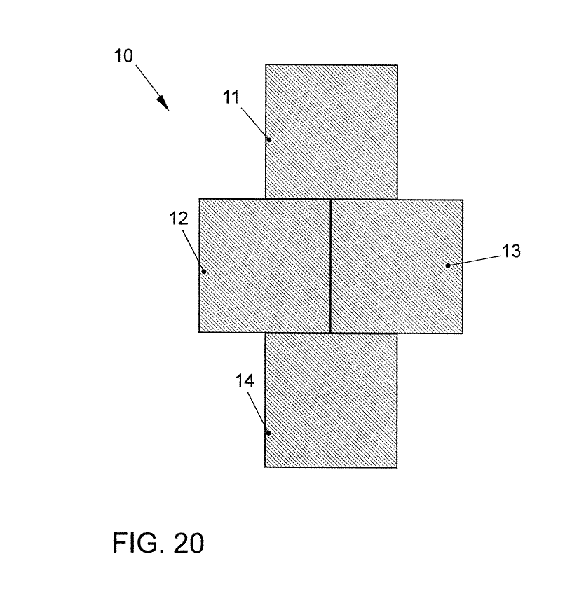

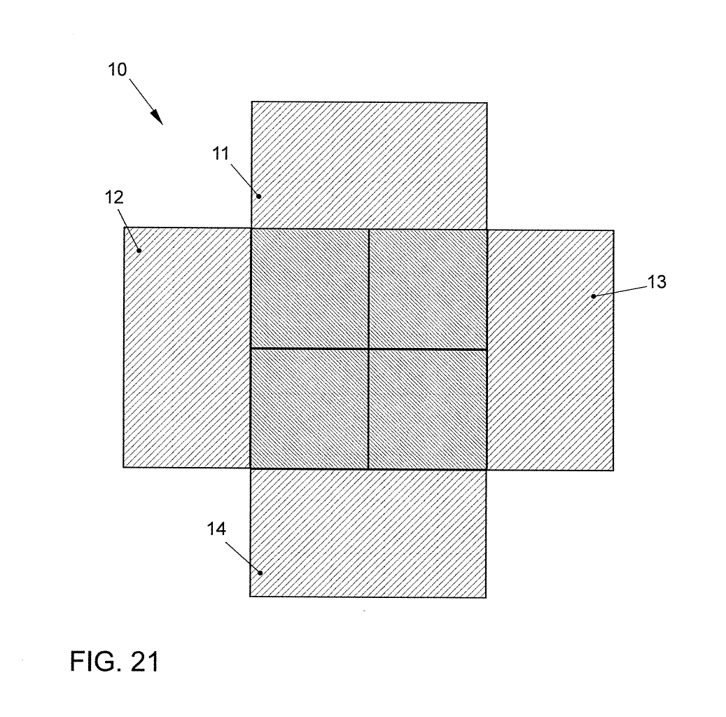

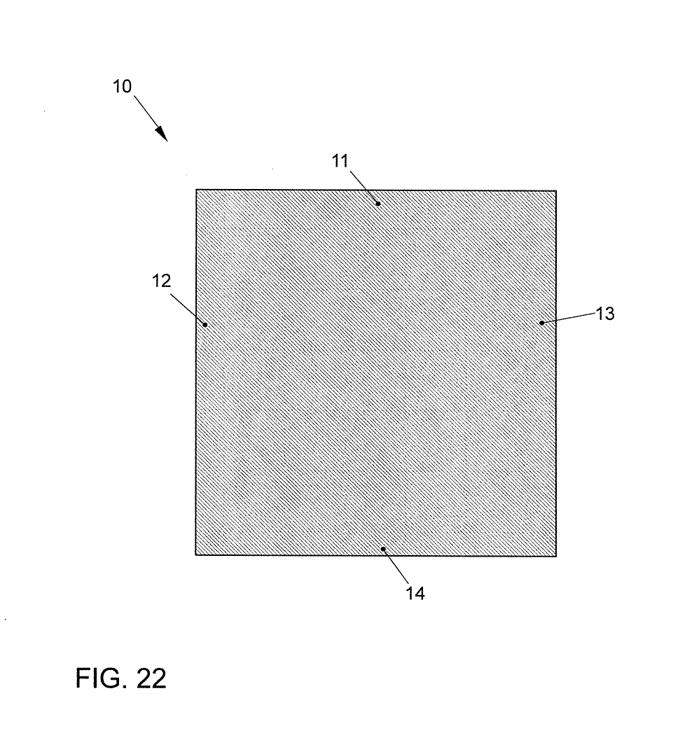

As is demonstrated figuratively by the implementation examples in FIGS. 13 to 18 on the basis of a twelfth, thirteenth, fourteenth, fifteenth or sixteenth embodiment, the air flow ducts 11, 12, 13, 14 can vary in their shape and number as well as in the angles and the arrangement with respect to one another and their size. In particular, the shaping of the air exit region is significant here. The zone in which the interacting air mass flows impact one against the other can be located in the duct as well as outside the duct or can even vary.

What is claimed is:

1. A personal air flow device for a vehicle, comprising:
a plurality of air flow ducts with a common air exit region for outflow of a desired total air mass flow,
each of the air flow ducts being connected to the air exit region in such a way that the air flow duct applies an air mass flow (\dot{m}₁, \dot{m}₂) to the air exit region,
the air mass flows (\dot{m}₁, \dot{m}₂) being controlled relative to one another in such a way that they are superimposed to form the total air mass flow.

2. The personal air flow device of claim 1, wherein:
at least one of the air flow ducts has a regulating fitting for reducing a cross section (A₁, A₂) of the air flow duct, and
the air mass flow (\dot{m}₁, \dot{m}₂) through the air flow duct having the regulating fitting can be controlled by the regulating fitting.

3. The personal air flow device of claim 1, wherein:
the personal air flow device is connectable to an air-conditioning unit of the vehicle, and
at least one of the air flow ducts is configured so that the air mass flow (\dot{m}₁, \dot{m}₂) through the air flow duct is regulated by the air-conditioning unit.

4. The personal air flow device of claim 1, further comprising local separation of the air flow ducts from one another.

5. The personal air flow device of claim 1, wherein:
at least one of the air flow ducts has an angle controller for varying an angle (α₁, α₂) of the air flow duct and thereby controlling the air mass flow (\dot{m}₁, \dot{m}₂) through the air flow duct that has the angle controller.

6. The personal air flow device of claim 5, wherein the angle controller comprises rigid air-directing elements for directing the air mass flows (\dot{m}₁, \dot{m}₂).

7. The personal air flow device of claim 5, wherein the angle controller does not comprise any air-directing elements for directing the air mass flows (\dot{m}₁, \dot{m}₂).

8. The personal air flow device of claim 1, wherein:
the air flow ducts comprise a main flow duct and a secondary flow duct,
the personal air flow device has, upstream of the main flow duct, means for generating a pressure difference between the main flow duct and the secondary flow duct, and
the air mass flow (\dot{m}₂) through the secondary flow duct can be controlled by the means.

9. The personal air flow device of claim 1, wherein:
the air flow ducts comprise two upper air flow ducts and two lower air flow ducts,
the upper air flow ducts are oriented at a variable angle (α₁) with respect to the lower air flow ducts,
each air flow duct has fixed air-directing elements in the air exit region, and
the air-directing elements are oriented in such a way that the air mass flows (\dot{m}₁, \dot{m}₂) of the upper air flow ducts and of the lower air flow ducts intersect.

10. The personal air flow device of claim 1, wherein the air exit region is shaped so that the air mass flows (\dot{m}₁, \dot{m}₂) interact within the personal air flow device.

11. The personal air flow device of claim 1, wherein the air exit region is shaped so that the air mass flows (\dot{m}₁, \dot{m}₂) interact outside the personal air flow device.
